(19) United States
(12) Patent Application Publication
(10) Pub. No.: US 2022/0309913 A1
(43) Pub. Date: Sep. 29, 2022

(54) METHOD FOR ACQUIRING TRAFFIC VOLUME AND ELECTRONIC DEVICE

(71) Applicant: APOLLO INTELLIGENT CONNECTIVITY (BEIJING) TECHNOLOGY CO,. LTD., BEIJING (CN)

(72) Inventor: Qiqi Xu, Beijing (CN)

(73) Assignee: APOLLO INTELLIGENT CONNECTIVITY (BEIJING) TECHNOLOGY CO,. LTD., BEIJING (CN)

(21) Appl. No.: 17/806,820

(22) Filed: Jun. 14, 2022

(30) Foreign Application Priority Data
Jun. 15, 2021 (CN) 202110662879.6

(51) Int. Cl. G08G 1/01

(52) U.S. Cl. CPC G08G 1/0145; G08G 1/0133; G08G 1/0141

(57) ABSTRACT

The disclosure provides a method for acquiring a traffic volume and an electronic device. The method includes: acquiring first feature information and signal timing information of each of the phases in a target road section; and acquiring a traffic volume of the whole road section in a current signal light control period of the target road section based on the first feature information and the signal timing information.

### CROSS-REFERENCE TO RELATED APPLICATION

This application claims priority to Chinese Patent Application No. 202110662879.6 filed on Jun. 15, 2021, the disclosure of which is hereby incorporated by reference in its entirety.

### TECHNICAL FIELD

The embodiments of the disclosure generally relate to a field of data processing technologies, and more specifically to a field of artificial intelligence, specifically to technical fields of deep learning, big data, and intelligent transportation technologies.

### BACKGROUND

An accurate traffic volume and a queue length are very important and basic traffic indicators for controlling traffic signals. However, due to the limitation of economic and installation costs, traffic detectors in the related art cannot cover the whole road section, so the traffic detectors cannot obtain accurate data. In particular, the detection range of traditional detection tools such as a coil geomagnetic sensor and the visual range of an electronic police road bayonet are limited, and coverage rate of the Internet data is low and the precision is poor, which easily lead to the problem that there is an out-of-sight blind area at almost all intersections. In this case, there are technical problems such as a poor confidence and a low practicability of the acquisition result in the process of acquiring a traffic volume in related art.

### SUMMARY

According to embodiments of the disclosure, a method for acquiring a traffic volume is provided, which is applied to a target road section with two intersections at both ends, each of the intersections including at least two phases in the same driving direction. The method includes: acquiring first feature information and signal timing information of each of the phases in the target road section; and based on the first feature information and the signal timing information, acquiring a traffic volume of the whole road section in the current signal light control period of the target road section.

According to embodiments of the disclosure, an electronic device is provided, and includes: at least one processor; and a memory communicatively coupled to the at least one processor; the memory is stored with instructions executable by the at least one processor, so that the at least one processor may perform a method for acquiring a traffic volume as described in the first aspect of the disclosure.

According to embodiments of the disclosure, a non-transitory computer readable storage medium stored with computer instructions is provided. The computer instructions are configured to perform the method for acquiring a traffic volume as described in the first aspect by the computer.

It should be understood that, the content described in the part is not intended to identify key or important features of embodiments of the disclosure, nor intended to limit the scope of the disclosure. Other features of the disclosure will be easy to understand through the following specification.

### BRIEF DESCRIPTION OF THE DRAWINGS

The drawings are intended to better understand the disclosure, and do not constitute a limitation to the disclosure.

FIG. 1 is a flow chart of a method for acquiring a traffic volume according to an embodiment of the disclosure;

FIG. 2 is a schematic diagram of a target road section;

FIG. 3 is a flow chart of a method for acquiring a traffic volume according to n embodiment of the disclosure;

FIG. 4 is a flow chart of a method for acquiring a traffic volume according to an embodiment of the disclosure;

FIG. 5 is a flow chart of a method for acquiring a traffic volume according to an embodiment of the disclosure;

FIG. 6 is a flow chart of a method for acquiring a traffic volume according to an embodiment of the disclosure;

FIG. 7 is a flow chart of a method for acquiring a traffic volume according to an embodiment of the disclosure;

FIG. 8 is a schematic diagram of overflow early warning recognition;

FIG. 9 is a block diagram of an apparatus for acquiring a traffic volume configured to implement a method for acquiring a traffic volume according to an embodiment of the disclosure;

FIG. 10 is a block diagram of an apparatus for acquiring a traffic volume configured to implement a method for acquiring a traffic volume according to an embodiment of the disclosure;

FIG. 11 is a block diagram of an electronic device configured to implement acquiring a traffic volume in the embodiment of the disclosure.

### DETAILED DESCRIPTION

The exemplary embodiments of the present disclosure are described as below with reference to the accompanying drawings, which include various details of embodiments of the present disclosure to facilitate understanding, and should be considered as merely exemplary. Therefore, those skilled in the art should realize that various changes and modifications may be made on the embodiments described herein without departing from the scope and spirit of the present disclosure. Similarly, for clarity and conciseness, descriptions of well-known functions and structures are omitted in the following descriptions.

The technical fields referred to in the disclosure are briefly introduced as below:

Data processing is collection, storage, retrieval, processing, conversion and transmission of data. The basic purpose of data processing is to extract and derive data valuable and meaningful to some certain people from a large amount of data that may be disordered and difficult to understand. Data processing is a basic link of system engineering and automatic control. Data processing runs through various areas of social production and social life.

Artificial intelligence (AI) is a subject that studies using a computer to simulate certain thinking processes and intelligent behaviors (such as learning, reasoning, thinking, planning, etc.) of human beings, which covers hardware-level technologies and software-level technologies. AI hardware technologies generally include computer vision technology, voice recognition technology, natural language processing (NLP) technology and machine learning/deep learning (DL), big data processing technology, knowledge graph technology, etc.

Deep learning (DL) refers to studying inherent law and representation levels of sample data, and information obtained in the learning process is of great help in interpretation of data such as texts, images and sound. Its final goal is that the machine may have analyzing and learning abilities like humans, and may recognize data such as texts, images, sound, etc. DL is a complicated machine learning algorithm, which has far outperformed the related art in speech and image recognition.

Big data means a set of data that cannot be captured, managed, and processed by a conventional software tool within a certain time range, and means massive, high-growth rate and diversified information assets which require a new processing model to have stronger decision-making power, insight, and process optimization capacities.

Intelligent transportation generally refers to an intelligent traffic system (ITS), also referred to as an intelligent transportation system, means effectively integrating advanced science and technologies (information technology, computer technology, data communication technology, sensor technology, electronic control technology, automatic control theory, operations planning, artificial intelligence, etc.) in traffic transportation, service control and vehicle manufacturing, to strengthen a link among vehicles, roads and users, hence forming a comprehensive transportation system that guarantees safety, enhances efficiency, improves environment and saves energy.

A method and an apparatus for acquiring a traffic volume and an electronic device in the embodiments of the disclosure are described below with reference with attached drawings.

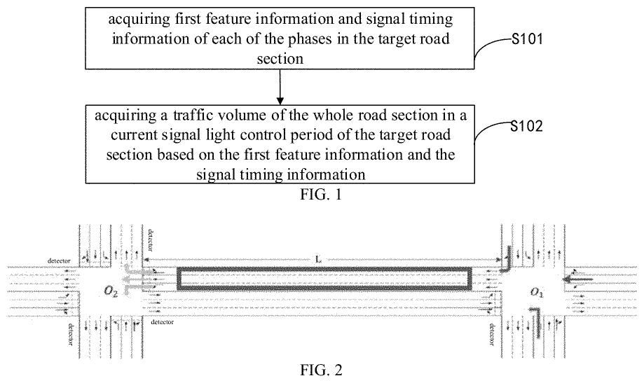

FIG. 1 is a diagram according to a first embodiment of the disclosure. It should be noted that, the executive body of the method for acquiring a traffic volume in the embodiments may be an apparatus for acquiring a traffic volume. The apparatus for acquiring a traffic volume may be a hardware device or a software in a hardware device, etc. The hardware device may be a terminal device, a server, etc.

As illustrated in FIG. 1, the method for acquiring a traffic volume in the embodiment is performed on a target road section with two intersections at both ends, each of the intersections including at least two phases in the same driving direction. The method includes:

At S101, first feature information and signal timing information of each of the phases in the target road section are acquired.

It should be noted that, the disclosure is suited for a target road section with two intersections at both ends, each of the intersections including at least two phases in the same driving direction.

For example, as illustrated in FIG. 2, an intersection O₁ and an intersection O₂ are respectively at the two ends of the target road section, and a length between the intersection O₁ and the intersection O₂ is L. For example, a vehicle drives into a west entrance lane at the intersection O₂ from the intersection O₁, based on standard phase control, for any intersection, the following phases with phase numbers 1 to 8 are included: South Straight (1), South Left (2), North Straight (3), North Left (4), West Straight (5), West Left (6), East Straight (7), East Left (8).

The first feature information of each phase may include but not limited to the following information: a traffic volume outflow rate of each lane, a number of lanes, a flow ratio (i.e., a ratio of an arrival flow to a saturation flow), etc.

The signal timing information (Signal Timing Dial) refers to a time allocation ratio of the signal lights at the intersections.

At S102, a traffic volume of the whole road section in a current signal light control period of the target road section is acquired based on the first feature information and the signal timing information.

In the embodiments of the disclosure, based on the first feature information and the signal timing information, a traffic volume of the whole road section in the current signal light control period of the target road section may be acquired.

The traffic volume of the whole road section refers to a total traffic volume of driving in and out at cycle level in the whole target road section.

Based on the method for acquiring a traffic volume in the embodiments of the disclosure, the first feature information and the signal timing information of each phase in the target road section may be acquired, and a traffic volume of the whole road section in the current signal light control period of the target road section is further acquired based on the first feature information and the signal timing information, to achieve acquisition of the traffic volume of the whole road section. Therefore, with the disclosure, no longer relying on the data collected by the detection tool directly as the only basis for acquiring a traffic volume, accumulation of a traffic volume of the whole road section may be accurately acquired based on the collected data, in combination with closed flow accumulation concept, light status and road network channelization, which enhances efficiency, accuracy and reliability in the process of acquiring a traffic volume.

It should be noted that, in the disclosure, when the traffic volume of the whole road section in the current signal light control period of the target road section is acquired based on the first feature information and the signal timing information, a traffic state of a phase may be acquired, and then the traffic volume of the whole road section may be acquired.

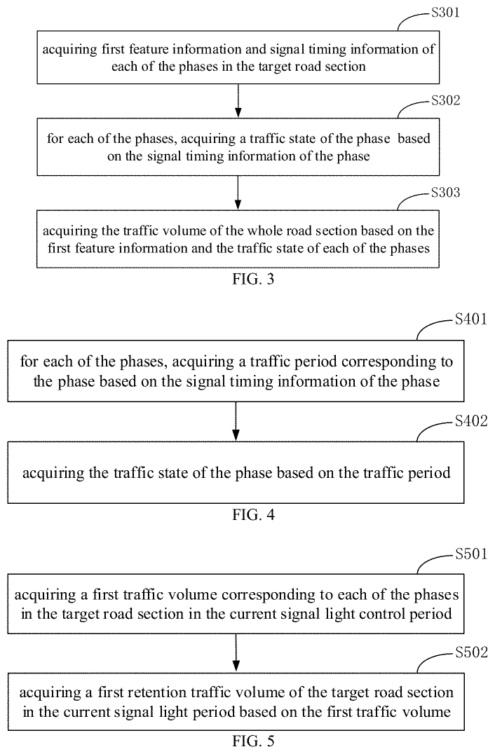

In a possible implementation, as illustrated in FIG. 3, on the basis of the above embodiment, it specifically includes the following blocks:

At S301, first feature information and signal timing information of each of the phases in the target road section are acquired.

The block S301 is the same with the block S101 in the above embodiment, which will not be repeated here.

The block S102 may include the following blocks S302-S303.

At S302, for each of the phases, a traffic state of the phase is acquired based on the signal timing information of the phase.

In a possible implementation, as illustrated in FIG. 4, on the basis of the above embodiment, the process of acquiring a traffic state of each of the phases based on the signal timing information of the phase at S302 includes the following blocks:

At S401, for each of the phases, a traffic period corresponding to the phase is acquired based on the signal timing information of the phase.

The traffic period corresponding to the phase refers to a duration available for traffic of each phase in a signal light control period, including a green-light time period and a yellow-light time period.

For example, for a 150 s signal light control period, traffic periods of the 8 phases at the intersection O₁ are respectively 23 s, 14 s, 16 s, 26 s, 30 s, 20 s, is and 20 s.

At S402, based on the traffic period, the traffic state of the phase is acquired.

In the embodiment of the disclosure, after the traffic period of the phase is acquired, the traffic state of the phase may be acquired based on a following formula:

$${Signal}_{ij} ( t ) = \{ \begin{matrix}1 , 0 < t < {p}_{ij} \\ 0 , {p}_{iij} < t < {T}_{i}\end{matrix}$$

where, Signalᵢⱼ(t) is a traffic state of a phase j at an intersection i, the traffic states 1 and 0 respectively represent that the phase may be passable and may be impassable, pᵢⱼ is a green-light time period of the phase j at the intersection i, Ti is the whole signal light control period (including the green-light time period, a yellow-light time period and a red-light time period) at the intersection i.

At S303, based on the first feature information and the traffic state of each of the phases, a traffic volume of the whole road section is acquired.

In the embodiment of the disclosure, in the signal light control period, an integral operation may be performed on the first feature information and the traffic state of each of the phases, and the results of the integral operation may be summed to obtain a traffic volume of the whole road section.

Optionally, the integral operation may be performed on the first feature information and the traffic state of each phase based on a following formula:

Qᵢⱼ=∫₀^{T}Signalᵢⱼ*qᵢⱼ(t)*Nⱼdt

where, Qᵢⱼ is an integral value in a signal light control period T of a phase j at an intersection i, qᵢⱼ(t) is a traffic volume outflow rate of a lane of the phase j at an intersection i, and Nⱼ is number of lanes corresponding to the phase j.

The traffic volume outflow rate of the lane in each phase may be acquired based on a saturation flow rate. Optionally, the saturation flow rate corresponding to the lane in each phase may be acquired, and then the saturation flow rate is divided by 3600, to acquire the traffic volume outflow rate of the lane in each phase.

It should be noted that, for different lanes, the saturation flow rates are also different.

The traffic volume outflow rate of each lane and the number of lanes corresponding to each phase are the first feature information of the phase, and may be acquired in a variety of ways, which is not limited in the disclosure. For example, the information may be acquired by querying Internet data.

Further, all the results of the integral operations are summed to obtain the traffic volume of the whole road section.

Based on the method for acquiring a traffic volume in the embodiment of the disclosure, for each phase, the traffic state of each phase may be acquired based on the signal timing information of the phase, and further the traffic volume of the whole road section may be acquired based on the first feature information and the traffic state of each of the phases. Thus, in the disclosure, the integral operation may be performed on the first feature information and the traffic state of each of the phases based on the collected data in combination with the concept of closed flow accumulation, and the results of the integral operations may be summed to obtain the traffic volume of the whole road section, which further improves the accuracy and reliability in the process of acquiring a traffic volume.

Further, in the disclosure, a retention traffic volume in the current period of the target road section may be further acquired based on the collected data.

In a possible implementation, as illustrated in FIG. 5, on the basis of the above embodiment, the method includes the following blocks:

At S501, a first traffic volume corresponding to each of the phases in the target road section in the current signal light control period is acquired.

The first traffic volume may be a traffic volume of any phase.

For example, taking a South-Left phase 1 as an example, the first traffic volume of the South-Left phase 1 is Q₁ₗⁿ.

It should be noted that, in the disclosure, the method for acquiring the first traffic volume is not limited, and may be selected based on actual conditions. Optionally, it may be acquired through a video or geomagnetic detection data collected by a detection apparatus.

At S502, based on the first traffic volume, a first retention traffic volume of the target road section is acquired.

The first retention traffic volume of the target road section may indicate a real-time congestion situation and a real-time queuing situation in the current signal light control period of the target road section.

In a possible implementation, as illustrated in FIG. 6, on the basis of the above embodiment, the process of acquiring the first retention traffic volume of the target road section based on the first traffic volume at block S502 includes the following blocks:

At S601, based on the first traffic volume, a second traffic volume at each of the intersections on the target road section is acquired.

The second traffic volume may be a traffic volume at any intersection.

In the embodiment of the disclosure, the second traffic volume may be acquired by adding the first traffic volumes of all phases corresponding to any intersection.

For example, the first traffic volumes corresponding to the intersection O₁ are respectively Q₁ₛ², Q₁ₗ², Q₁ᵣⁿ; the first traffic volumes corresponding to intersection O₂ are respectively Q₂ₛⁿ, Q₂ₗ², Q₂ᵣⁿ. In this case, the second traffic volume Q₁ⁿ at intersection O₁ and the second traffic volume Q₂ⁿ at intersection O₂ may be acquired based on the following formulas:

Q₁ⁿ=Q₁ₛⁿ+Q₁ₗⁿ—Q₁ᵣⁿ

Q₂ⁿ=Q₂ₛⁿ+Q₂ₗⁿ—Q₂ᵣⁿ

At S602, a second retention traffic volume of the target road section in a previous signal light control period is acquired.

It should be noted that, in the disclosure, a method for acquiring the second retention traffic volume is not limited, and may be selected based on actual conditions. Optionally, it may be acquired by querying Internet data.

At S603, based on the second traffic volume at each of the intersections and the second retention traffic volume in the previous period, the first retention traffic volume of the target road section in the current signal light control period is acquired.

For example, taking a vehicle driving into a west entrance lane at the intersection O₂ from the intersection O₁ as an example, the first retention traffic volume of the target road section may be acquired based on a following formula:

Q_{q}ⁿ=Q₁ⁿ−Q₂ⁿ+Q_{q}ⁿ⁻¹

where, Q_{q}ⁿ is the first retention traffic volume, Q₁ⁿ is a second traffic volume at the intersection O₁, Q₂ⁿ is a second traffic volume at the intersection O₂, and Q_{q}ⁿ⁻¹ is the second retention traffic volume in the previous signal light control period.

Based on the method for acquiring a traffic volume in the embodiments of the disclosure, the first traffic volume corresponding to each of the phases in the target road section in the current signal light control period may be acquired, and further the first retention traffic volume in the current signal light control period of the target road section may be acquired based on the first traffic volume, to achieve acquisition of the first retention traffic volume. Therefore, the disclosure no longer relies on the data collected by the detection tool directly as the only basis for acquiring a traffic volume. Based on the collected data, a retention traffic volume in the current signal light control period of the target road section may be accurately acquired, which enhances efficiency, accuracy and reliability in the process of acquiring a traffic volume.

Further, in the disclosure, based on the retention traffic volume in the current signal light control period, an overflow early warning may be performed on the target road section.

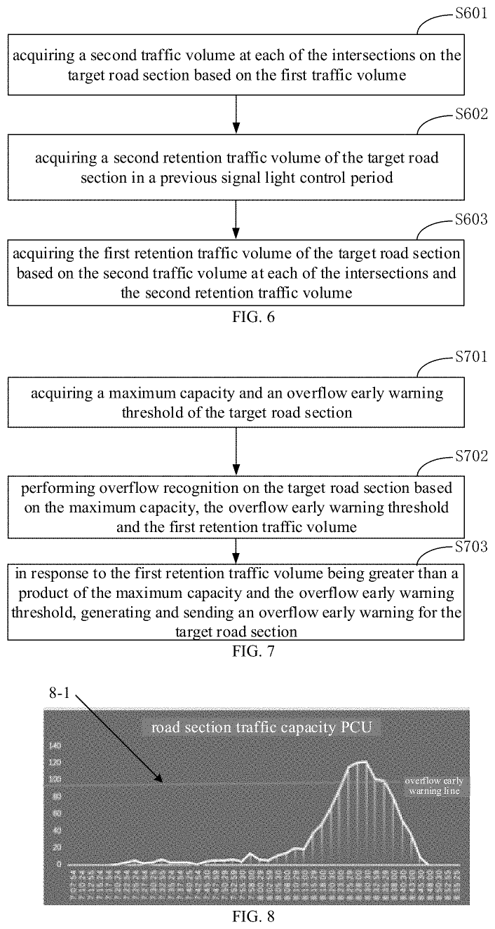

In a possible implementation, as illustrated in FIG. 7, on the basis of the above embodiment, the method includes the following blocks:

At S701, a maximum capacity and an overflow early warning threshold of the target road section are acquired.

It should be noted that, in the disclosure, a method for acquiring the maximum capacity and the overflow early warning threshold of the target road section is not limited, and may be selected based on actual conditions.

The maximum capacity of the target road section refers to a maximum number of queuing vehicles that the target road section is capable to accommodate.

In a possible implementation, second feature information of the target road section may be acquired, and the maximum capacity of the target road section may be acquired based on the second feature information. Optionally, a road section length, a number of lanes and a parking distance may be extracted from the second feature information, and an average vehicle-body length may be acquired from Internet data. Further, based on the road section length, the number of lanes, the parking distance and the average vehicle-body length, the maximum capacity of the target road section may be acquired based on a following formula:

$$C = \frac{L * N}{1 + Hc}$$

where, L is the road section length, N is the number of lanes, He is the parking distance, and 1 is an average vehicle-body length.

Further, the overflow early warning threshold may be extracted from the second feature information.

At S702, based on the maximum capacity, the overflow early warning threshold and the first retention traffic volume, overflow recognition is performed on the target road section.

At S703, in response to the first retention traffic volume being greater than a product of the maximum capacity and the overflow early warning threshold, an overflow early warning for the target road section is generated and sent.

In the embodiment of the disclosure, after the maximum capacity and the overflow early warning threshold are acquired, the first retention traffic volume may be compared with a product of the maximum capacity and the overflow early warning threshold. Optionally, in response to the first retention traffic volume being greater than the product of the maximum capacity and the overflow early warning threshold, the overflow early warning for the target road section is generated and sent; optionally, in response to the first retention traffic volume being less than or equal to the product of the maximum capacity and the overflow early warning threshold, the first retention traffic volume in the current signal light control period is acquired again.

It should be noted that, in the disclosure, the specific method for performing the overflow early warning is not limited, which may be set based on actual conditions. For example, the overflow early warning may be set to at least one of a sound warning, a text warning, and a photoelectric warning.

For example, as illustrated in FIG. 8, the line segment 8-1 drawn with the ordinate as the product of the maximum capacity and the overflow early warning threshold is an overflow critical condition, and in response to a traffic volume higher than the overflow critical condition, an overflow early warning may be triggered.

Based on the method for acquiring a traffic volume in the embodiments of the disclosure, the maximum capacity and the overflow early warning threshold of the target road section may be acquired, and the overflow recognition is performed on the target road section based on the maximum capacity, the overflow early warning threshold and the retention traffic volume in the current signal light control period, and further in response to the retention traffic volume in the current signal light control period being greater than the product of the maximum capacity and the overflow early warning threshold, the overflow early warning for the target road section is generated and sent. Therefore, in the disclosure, the target road section may be monitored in real time and accurately based on an accurate retention traffic volume in the current signal light control period, and it ensures that the target road section is maintained between an upper limit of not triggering the overflow early warning and a lower limit of eliminating green-empty loss based on an accurate overflow critical condition, which improves the adaptability in the process of acquiring a traffic volume.

It should be noted that, the acquisition, storage, and application of user personal information involved in the technical solution of the disclosure comply with relevant laws and regulations, and do not violate public order and good customs. The intention of the disclosure is to manage and process personal information data in a way of minimizing the risk of unintentional or unlicensed use access. The risk is minimized by restricting data collection and deleting data when it is no longer needed. It should be noted that all information related to the personnel in the disclosure is collected with the knowledge and consent of the personnel.

Corresponding to the method for acquiring a traffic volume provided by the above embodiments, one embodiment of the disclosure further provides an apparatus for acquiring a traffic volume. Since the apparatus for acquiring a traffic volume provided in the embodiments of the disclosure corresponds to the method for acquiring a traffic volume provided in the above several embodiments of the disclosure, the implementation of the method for acquiring a traffic volume is also suitable for the apparatus for acquiring a traffic volume provided in the embodiment, which will not be described in the embodiment.

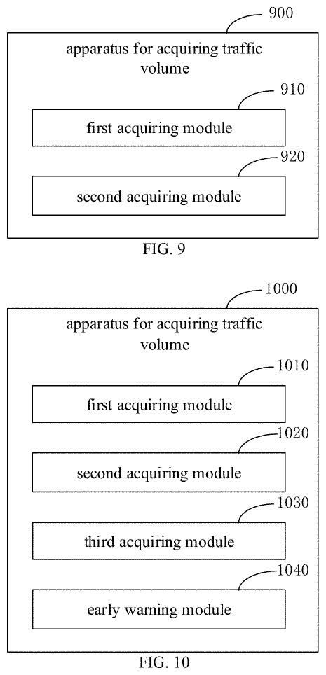

FIG. 9 is a block diagram of a structure of an apparatus for acquiring a traffic volume in one embodiment of the disclosure.

As illustrated in FIG. 9, the apparatus 900 for acquiring a traffic volume is suitable for a target road section with two intersections at both ends, each of the intersections including at least two phases in the same driving direction. The apparatus 900 includes a first acquiring module 910 and a second acquiring module 920.

The first acquiring module 910 is configured to acquire first feature information and signal timing information of each of the phases in the target road section.

The second acquiring module 920 is configured to, based on the first feature information and the signal timing information, acquire a traffic volume of the whole road section in the current signal light control period of the target road section.

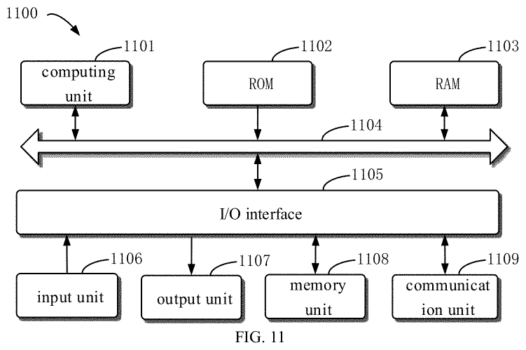

FIG. 10 is a block diagram of a structure of an apparatus for acquiring a traffic volume in another embodiment of the disclosure.

As illustrated in FIG. 10, the apparatus 1000 for acquiring a traffic volume is suitable for a target road section with two intersections at both ends, each of the intersections including at least two phases in the same driving direction. The apparatus 900 includes a first acquiring module 1010 and a second acquiring module 1020.

The second acquiring module 1020 is configured to: for each of the phases, based on the signal timing information of the phase, acquire a traffic state of the phase; and based on the first feature information and the traffic state of each of the phases, acquire a traffic volume of the whole road section.

The second acquiring module 1020 is further configured to: in the signal light control period, perform an integral operation on the first feature information and the traffic state of each of the phases, and sum the results of the integral operation, to obtain a traffic volume of the whole road section.

The second acquiring module 1020 is further configured to: for each of the phases, based on the signal timing information of the phase, acquire a traffic period corresponding to the phase; and acquire the traffic state of the phase based on the traffic period.

The apparatus 1000 for acquiring a traffic volume further includes a third acquiring module 1030.

The third acquiring module 1030 is configured to: acquire a first traffic volume corresponding to each of the phases in the target road section in the current signal light control period; and acquire a first retention traffic volume of the target road section in the current signal light period based on the first traffic volume.

The third acquiring module 1030 is further configured to: based on the first traffic volume, acquiring a second traffic volume at each of the intersections on the target road section; acquire a second retention traffic volume of the target road section in a previous signal light control period; and acquire the first retention traffic volume of the target road section based on the second traffic volumes at each of the intersections and the second retention traffic volume.

The apparatus 1000 for acquiring a traffic volume further includes an early warning module 1040.

The early warning module 1040 is configured to: acquire a maximum capacity and an overflow early warning threshold of the target road section; perform overflow recognition on the target road section based on the maximum capacity, the overflow early warning threshold and the first retention traffic volume; and in response to the first retention traffic volume being greater than a product of the maximum capacity and the overflow early warning threshold, generate and send an overflow early warning for the target road section.

The early warning module 1040 is further configured to: acquire second feature information of the target road section, and acquire the maximum capacity of the target road section based on the second feature information.

It should be noted that, the first acquiring module 1010 has the same function and structure with the first acquiring module 901.

Based on the apparatus for acquiring a traffic volume in the embodiments of the disclosure, the first feature information and the signal timing information of each phase in the target road section may be acquired, and a traffic volume of the whole road section in the current signal light control period of the target road section is further acquired based on the first feature information and the signal timing information, to achieve acquisition of the traffic volume of the whole road section. Therefore, with the disclosure, no longer relying on the data collected by the detection tool directly as the only basis for acquiring a traffic volume, accumulation of a traffic volume of the whole road section may be accurately acquired based on the collected data, in combination with closed flow accumulation concept, light status and road network channelization, which enhances efficiency, accuracy and reliability in the process of acquiring a traffic volume.

According to the embodiment of the disclosure, the disclosure further provides an electronic device, a readable storage medium and a computer program product.

FIG. 11 illustrates a schematic block diagram of an example electronic device 1100 configured to implement the embodiment of the disclosure. An electronic device is intended to represent various types of digital computers, such as laptop computers, desktop computers, workstations, personal digital assistants, servers, blade servers, mainframe computers, and other suitable computers. An electronic device may also represent various types of mobile apparatuses, such as personal digital assistants, cellular phones, smart phones, wearable devices, and other similar computing devices. The components shown herein, their connections and relations, and their functions are merely examples, and are not intended to limit the implementation of the disclosure described and/or required herein.

As illustrated in FIG. 11, the device 1100 includes a computing unit 1101, which may execute various appropriate actions and processings based on a computer program stored in a read-only memory (ROM) 1102 or a computer program loaded into a random access memory (RAM) 1103 from a storage unit 1108. In the RAM 1103, various programs and data required for operation of the device 1100 may also be stored. The computing unit 1101, the ROM 1002, and the RAM 1103 are connected to each other through a bus 1104. An input/output (I/O) interface 1105 is also connected to a bus 1104.

Several components in the device 1100 are connected to the I/O interface 1105, and include: an input unit 1106, for example, a keyboard, a mouse, etc.; an output unit 1107, for example, various types of displays, speakers, etc.; a storage unit 1108, for example, a magnetic disk, an optical disk, etc.; and a communication unit 1109, for example, a network card, a modem, a wireless communication transceiver, etc. The communication unit 1109 allows the device 1100 to exchange information/data with other devices over a computer network such as the Internet and/or various telecommunication networks.

A computing unit 1101 may be various types of general and/or dedicated processing components with processing and computing ability. Some examples of a computing unit 1101 include but not limited to a central processing unit (CPU), a graphics processing unit (GPU), various dedicated artificial intelligence (AI) computing chips, various computing units running a machine learning model algorithm, a digital signal processor (DSP), and any appropriate processor, controller, microcontroller, etc. The computing unit 1101 performs various methods and processings as described above, for example, a method for acquiring a traffic volume as described in a first embodiment of the disclosure. For example, in some embodiments, a method for acquiring a traffic volume may be further implemented as a computer software program, which is physically contained in a machine readable medium, such as a memory unit 1108. In some embodiments, a part or all of the computer program may be loaded and/or installed on the device 1100 through a ROM 1102 and/or a communication unit 1109. When the computer program is loaded on a RAM 1103 and performed by a computing unit 1101, one or more blocks in the above method for acquiring a traffic volume may be performed. Alternatively, in other embodiments, a computing unit 1101 may be configured to perform a method for acquiring a traffic volume as described in a first embodiment of the disclosure in other appropriate ways (for example, by virtue of a firmware).

Various implementation modes of the systems and technologies described above may be implemented in a digital electronic circuit system, a field programmable gate array (FPGA), an application-specific integrated circuit (ASIC), an application specific standard product (ASSP), a system-on-chip (SOC) system, a complex programmable logic device, a computer hardware, a firmware, a software, and/or combinations thereof. The various implementation modes may include: being implemented in one or more computer programs, and the one or more computer programs may be executed and/or interpreted on a programmable system including at least one programmable processor, and the programmable processor may be a dedicated or a general-purpose programmable processor that may receive data and instructions from a storage system, at least one input apparatus, and at least one output apparatus, and transmit the data and instructions to the storage system, the at least one input apparatus, and the at least one output apparatus.

A computer code configured to execute a method in the present disclosure may be written with one or any combination of a plurality of programming languages. The programming languages may be provided to a processor or a controller of a general purpose computer, a dedicated computer, or other apparatuses for repairing a programmable character image so that the function/operation specified in the flowchart and/or block diagram may be performed when the program code is executed by the processor or controller. A computer code may be performed completely or partly on the machine, performed partly on the machine as an independent software package and performed partly or completely on the remote machine or server.

In the context of the disclosure, a machine-readable medium may be a tangible medium that may contain or store a program intended for use in or in conjunction with an instruction execution system, apparatus, or device. A machine readable medium may be a machine readable signal medium or a machine readable storage medium. A machine readable storage medium may include but not limited to an electronic, magnetic, optical, electromagnetic, infrared, or semiconductor system, apparatus or device, or any appropriate combination thereof. A more specific example of a machine readable storage medium includes an electronic connector with one or more cables, a portable computer disk, a hardware, a random access memory (RAM), a read-only memory (ROM), an erasable programmable read-only memory (an EPROM or a flash memory), an optical fiber device, and a portable optical disk read-only memory (CDROM), an optical storage device, a magnetic storage device, or any appropriate combination of the above.

In order to provide interaction with the user, the systems and technologies described here may be implemented on a computer, and the computer has: a display apparatus for displaying information to the user (for example, a CRT (cathode ray tube) or a LCD (liquid crystal display) monitor); and a keyboard and a pointing apparatus (for example, a mouse or a trackball) through which the user may provide input to the computer. Other types of apparatuses may further be configured to provide interaction with the user; for example, the feedback provided to the user may be any form of sensory feedback (for example, visual feedback, auditory feedback, or tactile feedback); and input from the user may be received in any form (including an acoustic input, a voice input, or a tactile input).

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation mode of the system and technology described herein), or a computing system including any combination of such back-end components, middleware components or front-end components. The system components may be connected to each other through any form or medium of digital data communication (for example, a communication network). Examples of communication networks include: a local area network (LAN), a wide area network (WAN), an internet and a blockchain network.

The computer system may include a client and a server. The client and server are generally far away from each other and generally interact with each other through a communication network. The relationship between the client and the server is generated by computer programs running on the corresponding computer and having a client-server relationship with each other. A server may be a cloud server, also known as a cloud computing server or a cloud host, is a host product in a cloud computing service system, to solve the shortcomings of large management difficulty and weak business expansibility existed in the traditional physical host and Virtual Private Server (VPS) service. A server further may be a server with a distributed system, or a server in combination with a blockchain.

In the disclosure, a computer program product including a computer program is provided, the computer program being configured to implement a method for acquiring a traffic volume when performed by a processor as described in the first aspect of the embodiment of the disclosure.

It should be understood that, various forms of procedures shown above may be configured to reorder, add or delete steps. For example, steps described in the disclosure may be executed in parallel, sequentially, or in different orders, as long as the desired result of the technical solution disclosed in the present disclosure may be achieved, which will not be limited herein.

The above specific implementations do not constitute a limitation on the protection scope of the disclosure. Those skilled in the art should understand that various modifications, combinations, sub-combinations and substitutions may be made according to design requirements and other factors. Any modification, equivalent replacement, improvement, etc., made within the spirit and principle of embodiments of the present disclosure shall be included within the protection scope of the present disclosure.

What is claimed is:

1. A method for acquiring a traffic volume, performed on a target road section with two intersections at both ends, each of the intersections comprises at least two phases in a same driving direction, the method comprising:
acquiring first feature information and signal timing information of each of the phases in the target road section; and
acquiring a traffic volume of the whole road section in a current signal light control period of the target road section based on the first feature information and the signal timing information.

2. The method of claim 1, wherein, acquiring the traffic volume of the whole road section in the current signal light control period of the target road section based on the first feature information and the signal timing information comprises:
for each of the phases, acquiring a traffic state of the phase based on the signal timing information of the phase; and
acquiring the traffic volume of the whole road section based on the first feature information and the traffic state of each of the phases.

3. The method of claim 2, wherein, acquiring the traffic volume of the whole road section based on the first feature information and the traffic state of each of the phases comprises:
in the signal light control period, performing an integral operation on the first feature information and the traffic state of each of the phases, and summing results of the integral operations, to obtain the traffic volume of the whole road section.

4. The method of claim 2, wherein, for each of the phases, acquiring the traffic state of the phase based on the signal timing information of the phase comprises:
for each of the phases, acquiring a traffic period corresponding to the phase based on the signal timing information of the phase; and
acquiring the traffic state of the phase based on the traffic period.

5. The method of claim 1, wherein, further comprising:
acquiring a first traffic volume corresponding to each of the phases in the target road section in the current signal light control period; and
acquiring a first retention traffic volume of the target road section in the current signal light period based on the first traffic volume.

6. The method of claim 5, wherein, acquiring the first retention traffic volume of the target road section in the current signal light period based on the first traffic volume comprising:
acquiring a second traffic volume at each of the intersections on the target road section based on the first traffic volume;
acquiring a second retention traffic volume of the target road section in a previous signal light control period; and
acquiring the first retention traffic volume of the target road section based on the second traffic volume at each of the intersections and the second retention traffic volume.

7. The method of claim 5, wherein, further comprising:
acquiring a maximum capacity and an overflow early warning threshold of the target road section;
performing overflow recognition on the target road section based on the maximum capacity, the overflow early warning threshold and the first retention traffic volume; and
in response to the first retention traffic volume being greater than a product of the maximum capacity and the overflow early warning threshold, generating and sending an overflow early warning for the target road section.

8. The method of claim 7, wherein, acquiring the maximum capacity of the target road section, comprising:
acquiring second feature information of the target road section, and acquiring the maximum capacity of the target road section based on the second feature information.

9. An electronic device, wherein, comprising a processor and a memory;
wherein, the processor runs a program corresponding to an executable program code by reading the executable program code stored in the memory, to implement a method for acquiring a traffic volume, performed on a target road section with two intersections at both ends, each of the intersections comprises at least two phases in a same driving direction, the method comprising:
acquiring first feature information and signal timing information of each of the phases in the target road section; and
acquiring a traffic volume of the whole road section in a current signal light control period of the target road section based on the first feature information and the signal timing information.

10. The electronic device of claim 9, wherein, acquiring the traffic volume of the whole road section in the current signal light control period of the target road section based on the first feature information and the signal timing information comprises:
for each of the phases, acquiring a traffic state of the phase based on the signal timing information of the phase; and
acquiring the traffic volume of the whole road section based on the first feature information and the traffic state of each of the phases.

11. The electronic device of claim 10, wherein, acquiring the traffic volume of the whole road section based on the first feature information and the traffic state of each of the phases comprises:
in the signal light control period, performing an integral operation on the first feature information and the traffic state of each of the phases, and summing results of the integral operations, to obtain the traffic volume of the whole road section.

12. The electronic device of claim 10, wherein, for each of the phases, acquiring the traffic state of the phase based on the signal timing information of the phase comprises:
for each of the phases, acquiring a traffic period corresponding to the phase based on the signal timing information of the phase; and
acquiring the traffic state of the phase based on the traffic period.

13. The electronic device of claim 9, wherein, the method further comprises:
acquiring a first traffic volume corresponding to each of the phases in the target road section in the current signal light control period; and
acquiring a first retention traffic volume of the target road section in the current signal light period based on the first traffic volume.

14. The electronic device of claim 13, wherein, acquiring the first retention traffic volume of the target road section in the current signal light period based on the first traffic volume comprising:
acquiring a second traffic volume at each of the intersections on the target road section based on the first traffic volume;
acquiring a second retention traffic volume of the target road section in a previous signal light control period; and
acquiring the first retention traffic volume of the target road section based on the second traffic volume at each of the intersections and the second retention traffic volume.

15. The method of claim 13, wherein, the method further comprises:
acquiring a maximum capacity and an overflow early warning threshold of the target road section;
performing overflow recognition on the target road section based on the maximum capacity, the overflow early warning threshold and the first retention traffic volume; and
in response to the first retention traffic volume being greater than a product of the maximum capacity and the overflow early warning threshold, generating and sending an overflow early warning for the target road section.

16. The method of claim 15, wherein, acquiring the maximum capacity of the target road section, comprising:
acquiring second feature information of the target road section, and acquiring the maximum capacity of the target road section based on the second feature information.

17. A non-transitory computer readable storage medium having a computer program stored thereon, wherein a method for acquiring a traffic volume, performed on a target road section with two intersections at both ends, each of the intersections comprises at least two phases in a same driving direction, the method comprising:
acquiring first feature information and signal timing information of each of the phases in the target road section; and
acquiring a traffic volume of the whole road section in a current signal light control period of the target road section based on the first feature information and the signal timing information.

18. The non-transitory computer readable storage medium of claim 17, wherein, acquiring the traffic volume of the whole road section in the current signal light control period of the target road section based on the first feature information and the signal timing information comprises:
for each of the phases, acquiring a traffic state of the phase based on the signal timing information of the phase; and
acquiring the traffic volume of the whole road section based on the first feature information and the traffic state of each of the phases.

19. The non-transitory computer readable storage medium of claim 18, wherein, acquiring the traffic volume of the whole road section based on the first feature information and the traffic state of each of the phases comprises:
in the signal light control period, performing an integral operation on the first feature information and the traffic state of each of the phases, and summing results of the integral operations, to obtain the traffic volume of the whole road section.

20. The non-transitory computer readable storage medium of claim 18, wherein, for each of the phases, acquiring the traffic state of the phase based on the signal timing information of the phase comprises:
for each of the phases, acquiring a traffic period corresponding to the phase based on the signal timing information of the phase; and
acquiring the traffic state of the phase based on the traffic period.
